(19) United States
(12) Patent Application Publication
(10) Pub. No.: US 2026/0146570 A1
(43) Pub. Date: May 28, 2026

(54) VEHICLE

(71) Applicant: SUBARU CORPORATION, Tokyo (JP)

(72) Inventor: Ko SATO, Tokyo (JP)

(21) Appl. No.: 19/383,903

(22) Filed: Nov. 10, 2025

(30) Foreign Application Priority Data
Nov. 25, 2024 (JP) 2024-205055

(51) Int. Cl. F02D 41/00

(52) U.S. Cl. CPC F02D 41/0045; F02D 41/0007; F02D 41/008

(57) ABSTRACT

A vehicle includes an engine including cylinders, an intake air flow path coupled to the engine, a supercharger configured to pressurize intake air to be supplied to the engine through the intake air flow path, a fuel tank configured to store fuel, a canister configured to temporarily store evaporated fuel generated in the fuel tank, an ejector mechanism including an ejector body provided upstream of the supercharger along the intake air flow path, a return flow path configured to couple the intake air flow path and the ejector body at a position downstream of the supercharger, and a purge flow path configured to couple the canister and the ejector body, and a control device configured to control the engine and the supercharger. The control device includes one or more processors configured to set an operation mode of the engine and the supercharger to a purge priority mode.

### CROSS-REFERENCE TO RELATED APPLICATIONS

The present application claims priority from Japanese Patent Application No. 2024-205055 filed on November 25, 2024, the entire contents of which are hereby incorporated by reference.

### BACKGROUND

The disclosure relates to vehicles.

Conventionally, vehicles use a technology in which evaporated fuel generated in a fuel tank is supplied to intake air flow paths of the engine, thereby combusting the evaporated fuel in the combustion chamber. For example, Japanese Patent No. 4479830 discloses provision of a canister that adsorbs evaporated fuel, a purge path that couples the canister and an intake air pipe of the engine, and a purge control valve provided along the purge path.

### SUMMARY

An aspect of the disclosure provides a vehicle including an engine, an intake air flow path, a supercharger, a fuel tank, a canister, an ejector mechanism, and a control device. The engine includes cylinders. The intake air flow path is coupled to the engine. The supercharger is configured to pressurize intake air to be supplied to the engine through the intake air flow path. The fuel tank is configured to store fuel to be supplied to the engine. The canister is configured to temporarily store evaporated fuel generated in the fuel tank. The ejector mechanism includes an ejector body provided upstream of the supercharger along the intake air flow path, a return flow path configured to couple part of the intake air flow path and the ejector body at a position downstream of the supercharger, and a purge flow path configured to couple the canister and the ejector body. The control device is configured to control the engine and the supercharger. The control device includes one or more processors and one or more memories coupled to the one or more processors. The one or more processors are configured to perform a first setting process to set an operation mode of the engine and the supercharger to a purge priority mode. The purge priority mode is an operation mode in which a supercharging pressure from the supercharger is increased to a second supercharging pressure that is higher than a first supercharging pressure during an all-cylinder operation, while performing a reduced-cylinder operation in which one or more of the cylinders are stopped, and purge gas containing the evaporated fuel is supplied from the ejector mechanism to the intake air flow path.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating a schematic configuration of a vehicle according to an embodiment of the disclosure;

FIG. 2 is a block diagram illustrating the functional configuration of a control device according to the embodiment;

FIG. 3 is a flowchart illustrating an example of the flow of a process performed by the control device according to the embodiment;

FIG. 4 is a flowchart illustrating an example of the flow in Step S116 performed by the control device according to the embodiment; and

FIG. 5 includes graphs describing the transition of the concentration of evaporated fuel, the transition of a first fuel amount, the transition of a fuel amount supplied from an injector, and the flow rate of purge gas in a purge priority mode and a fuel-economy priority mode.

### DETAILED DESCRIPTION

In the above technology for combustion of evaporated fuel generated in the fuel tank in the combustion chamber, development of technology for efficiently supplying evaporated fuel to the intake air flow paths of the engine is being sought.

It is desirable to provide a vehicle capable of efficiently supplying evaporated fuel to the intake air flow paths of the engine.

The following is a detailed description of an embodiment of the disclosure with reference to the accompanying drawings. The dimensions, materials, numerical values, etc. indicated in such embodiments are merely examples to facilitate understanding of the disclosure and do not limit the disclosure unless specifically stated otherwise. In this specification and the drawings, redundant description is omitted by assigning the same reference numerals to elements having substantially the same functions and configurations. Moreover, elements not directly related to the disclosure are omitted from the illustrations.

### 1. Vehicle Configuration

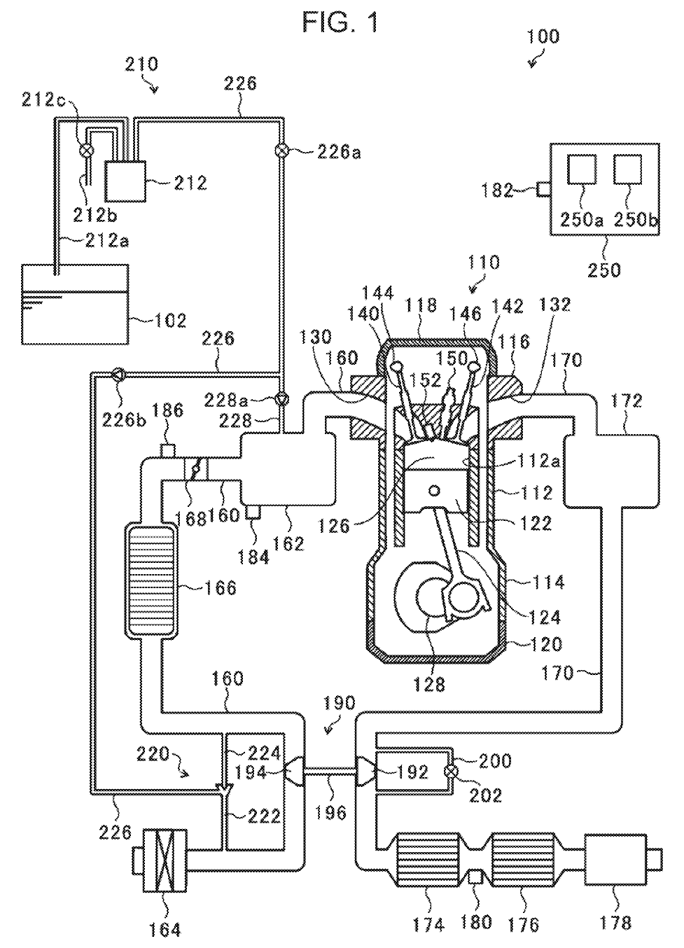

First, the configuration of a vehicle 100 according to an embodiment of the disclosure will be described with reference to FIG. 1. FIG. 1 is a schematic diagram illustrating a schematic configuration of the vehicle 100 according to the embodiment of the disclosure. As illustrated in FIG. 1, the vehicle 100 includes, for example, a fuel tank 102, an engine 110, an intake air flow path 160, an exhaust gas flow path 170, an air-fuel ratio sensor 180, an atmospheric pressure sensor 182, a first pressure sensor 184, a second pressure sensor 186, a supercharger 190, an evaporated fuel processing device 210, and a control device 250.

The fuel tank 102 stores fuel to be supplied to the engine 110. The fuel tank 102 is, for example, a sealed container and stores liquid fuel. In the fuel tank 102, the liquid fuel vaporizes to produce gaseous fuel, namely evaporated fuel. The fuel tank 102 is coupled to an injector 150 and a canister 212 of the evaporated fuel processing device 210, which are described below. The injector 150 is supplied with the liquid fuel from the fuel tank 102. In contrast, the canister 212 of the evaporated fuel processing device 210 is supplied with the evaporated fuel from the fuel tank 102.

The engine 110 serves as a drive source for the vehicle 100. That is, the vehicle 100 is a vehicle with an engine. The engine 110 is a gasoline engine or a diesel engine. Note that the vehicle 100 may be a hybrid vehicle with a motor as a drive source in addition to the engine 110.

In the present embodiment, the engine 110 is a multi-cylinder engine having cylinders 112a. The engine 110 includes, for example, a cylinder block 112, a crankcase 114, a cylinder head 116, a head cover 118, an oil pan 120, pistons 122, connecting rods 124, a crankshaft 128, intake valves 140, exhaust valves 142, intake valve cams 144, exhaust valve cams 146, injectors 150, and spark plugs 152.

The crankcase 114 is formed so as to be integrated with the cylinder block 112. The cylinder head 116 is joined to the cylinder block 112 on the opposite side from the crankcase 114. The head cover 118 is joined to the cylinder head 116 on the opposite side from the cylinder block 112. The oil pan 120 is joined to the crankcase 114 on the opposite side from the cylinder block 112.

The cylinder block 112 includes the cylinders 112a. In the present embodiment, the cylinder block 112 includes, for example, four cylinders 112a. In the cylinders 112a, the respective pistons 122 are slidably supported by the connecting rods 124. In the engine 110, the space enclosed by the cylinders 112a, the cylinder head 116, and the top surfaces of the pistons 122, which are slidably supported in the respective cylinders 112a, is formed as a combustion chamber 126.

In the engine 110, the space enclosed by the crankcase 114 and the oil pan 120 is formed as a crank chamber. The crankshaft 128 is rotatably supported in the crank chamber. The pistons 122 are connected to the crankshaft 128 via the connecting rods 124.

The cylinder head 116 is provided with intake ports 130 and exhaust ports 132 that communicate with the combustion chamber 126. An end of each intake valve 140 is located between the intake port 130 and the combustion chamber 126. An end of each exhaust valve 142 is located between the exhaust port 132 and the combustion chamber 126.

In the engine 110, the space enclosed by the cylinder head 116 and the head cover 118 is formed as a cam chamber. The intake valve cams 144 and the exhaust valve cams 146 are provided in the cam chamber. Each intake valve cam 144 is in contact with the other end of the intake valve 140. The intake valve cam 144 rotates to cause the intake valve 140 to come into contact with and separate from the valve seat of the intake port 130. The intake valve 140 thereby opens and closes the intake port 130 into the combustion chamber 126. Each exhaust valve cam 146 is in contact with the other end of the exhaust valve 142. The exhaust valve cam 146 rotates to cause the exhaust valve 142 to come into contact with and separate from the valve seat of the exhaust port 132. The exhaust valve 142 thereby opens and closes the exhaust port 132 into the combustion chamber 126.

The cylinder head 116 is provided with the injectors 150 such that their fuel injection ports open into the combustion chamber 126. The injectors 150 supply fuel stored in the fuel tank 102 to the combustion chamber 126 of the engine 110. The cylinder head 116 is provided with the spark plugs 152 such that their tips are located in the combustion chamber 126. Fuel injected from each injector 150 to the combustion chamber 126 mixes with air supplied from the intake port 130 to the combustion chamber 126 to form an air-fuel mixture. The spark plug 152 is then ignited at a predetermined timing, and the air-fuel mixture generated in the combustion chamber 126 is combusted. Such combustion results in a reciprocating motion of the pistons 122, which is converted into a rotational motion of the crankshaft 128 through the connecting rods 124.

The intake air flow path 160 is coupled to the engine 110. In the present embodiment, the intake air flow path 160 includes an intake manifold 162. The intake manifold 162 is coupled to the intake ports 130 formed for the respective cylinders 112a of the engine 110.

For example, an air cleaner 164, an intercooler 166, and a throttle valve 168 are provided upstream of the intake manifold 162 along the intake air flow path 160.

The air cleaner 164 removes dust, dirt, and other foreign matter contained in the air drawn into the intake air flow path 160. The intercooler 166 is provided between the air cleaner 164 and the intake manifold 162 along the intake air flow path 160. The intercooler 166 is, for example, a heat exchanger that exchanges heat between intake air flowing in the intake air flow path 160 and outside air. The intercooler 166 cools the intake air flowing in the intake air flow path 160.

The throttle valve 168 is provided between the intercooler 166 and the intake manifold 162 along the intake air flow path 160. The throttle valve 168 is driven by an actuator to open and close in accordance with the opening degree of the accelerator pedal (not illustrated). The throttle valve 168 adjusts the flow rate of intake air sent through the intake air flow path 160 to the engine 110 in accordance with the opening degree of the accelerator pedal. The flow rate of intake air sent to the engine 110 changes with the opening degree of the throttle valve 168.

The exhaust gas flow path 170 is coupled to the engine 110. In the present embodiment, the exhaust gas flow path 170 includes an exhaust manifold 172. The exhaust manifold 172 is coupled to the exhaust ports 132 formed for the respective cylinders 112a of the engine 110.

For example, catalysts 174 and 176 and a muffler 178 are provided downstream of the exhaust manifold 172 along the exhaust gas flow path 170.

The catalysts 174 and 176 purify exhaust gas discharged from the engine 110. The catalyst 174 is, for example, a three-way catalyst. The catalyst 176 is, for example, a NOx storage-reduction catalyst. The exhaust gas purified by the catalysts 174 and 176 is discharged to the outside through the muffler 178.

The air-fuel ratio sensor 180 is provided, for example, between the catalyst 174 and the catalyst 176 along the exhaust gas flow path 170. The air-fuel ratio sensor 180 detects the air-fuel ratio of the exhaust gas flowing in the exhaust gas flow path 170. The air-fuel ratio sensor 180 is, for example, an air fuel (A/F) sensor.

The atmospheric pressure sensor 182 is provided, for example, in the housing of the control device 250, which is described below. The atmospheric pressure sensor 182 detects atmospheric pressure.

The first pressure sensor 184 is provided, for example, in or at the intake manifold 162. The first pressure sensor 184 detects the pressure in the intake manifold 162.

The second pressure sensor 186 is provided, for example, between the intercooler 166 and the throttle valve 168 along the intake air flow path 160. The second pressure sensor 186 detects the pressure upstream of the throttle valve 168.

The supercharger 190 pressurizes the intake air to be supplied to the engine 110 through the intake air flow path 160. In the present embodiment, the supercharger 190 includes, for example, a turbine 192, a compressor 194, a turbine shaft 196, a bypass flow path 200, and a wastegate valve 202.

The turbine 192 is provided upstream of the catalyst 174 along the exhaust gas flow path 170. The compressor 194 is provided between the air cleaner 164 and the intercooler 166 along the intake air flow path 160. The turbine shaft 196 couples the turbine 192 and the compressor 194 so that the turbine 192 and the compressor 194 can rotate as a single unit. The turbine 192 is rotated by exhaust gas discharged from the exhaust ports 132. The compressor 194 rotates as the turbine 192 rotates, and compresses and supplies downstream the intake air that has had foreign matter removed by the air cleaner 164.

The bypass flow path 200 is provided along the exhaust gas flow path 170 so as to bypass the turbine 192. The wastegate valve 202 is provided along the bypass flow path 200. The wastegate valve 202 adjusts the opening degree of the bypass flow path 200. That is, the wastegate valve 202 adjusts the flow rate of exhaust gas flowing in the bypass flow path 200. The wastegate valve 202 is, for example, a solenoid valve.

The evaporated fuel processing device 210 supplies evaporated fuel together with air to the combustion chamber 126 of the engine 110 to suppress the release of evaporated fuel into the atmosphere. Evaporated fuel is generated inside the fuel tank 102. The evaporated fuel processing device 210 includes the canister 212 and an ejector mechanism 220.

The canister 212 temporarily stores evaporated fuel generated in the fuel tank 102. For example, the canister 212 contains activated carbon that adsorbs evaporated fuel such that the evaporated fuel can be desorbed. An evaporated fuel flow path 212a, an atmospheric release flow path 212b, and a first purge flow path 226 of the ejector mechanism 220, which will be described below, are coupled to the canister 212.

The evaporated fuel flow path 212a couples the fuel tank 102 and the canister 212. The evaporated fuel generated in the fuel tank 102 is supplied to the canister 212 through the evaporated fuel flow path 212a. The atmospheric release flow path 212b opens the canister 212 to the atmosphere. Note that the atmospheric release flow path 212b is provided with an air filter (not illustrated) and a valve 212c. The air filter removes dust, dirt, and other foreign matter from the air to be drawn into the canister 212. The valve 212c opens and closes the atmospheric release flow path 212b. The valve 212c is opened when evaporated fuel stored in the canister 212 is supplied together with air to the combustion chamber 126 of the engine 110. Hereinafter, the mixture of evaporated fuel and air will be referred to as purge gas. The valve 212c is, for example, a solenoid valve.

The ejector mechanism 220 has an ejector body 222, a return flow path 224, and the first purge flow path 226 (a purge flow path). The ejector body 222 is provided upstream of the supercharger 190 along the intake air flow path 160. In the present embodiment, the ejector body 222 is provided between the air cleaner 164 and the compressor 194 of the supercharger 190 along the intake air flow path 160.

The return flow path 224 couples the downstream side from the supercharger 190 and the ejector body 222 along the intake air flow path 160. In the present embodiment, the return flow path 224 is coupled to the ejector body 222at a position, on the intake air flow path 160, between the compressor 194 of the supercharger 190 and the intercooler 166. An end of the return flow path 224 coupled to the ejector body 222 is a tapered nozzle with the cross-sectional area of the flow path decreasing gradually toward the tip.

The first purge flow path 226 couples the canister 212 and the ejector body 222. The first purge flow path 226 has a valve 226a and a check valve 226b. The valve 226a adjusts the opening degree of the first purge flow path 226. That is, the valve 226a adjusts the flow rate of purge gas flowing in the first purge flow path 226. The valve 226a is, for example, a solenoid valve. The check valve 226b is provided between the valve 226a and the ejector body 222 along the first purge flow path 226. The check valve 226b prevents backflow of intake air from the return flow path 224.

In addition, the evaporated fuel processing device 210 may include a second purge flow path 228. The second purge flow path 228 couples the first purge flow path 226 and the intake air flow path 160. In the present embodiment, the second purge flow path 228 couples part of the first purge flow path 226 between the valve 226a and the check valve 226b and the intake manifold 162. In addition, the second purge flow path 228a has a check valve 228a. The check valve 228a prevents backflow of intake air from the intake manifold 162.

The control device 250 controls the engine 110 and the supercharger 190. The control device 250 includes one or more processors 250a and one or more memories 250b coupled to the one or more processors 250a. The one or more processors 250a include, for example, a central processing unit (CPU). The one or more memories 250b include, for example, a read-only memory (ROM) and a random access memory (RAM). A ROM is a storage device that stores, for example, programs and calculation parameters used by the CPU. A RAM is a storage device that temporarily stores variables, parameters, and other data used in processing performed by the CPU.

The control device 250 communicates with individual devices provided in the vehicle 100. The individual devices are, for example, the engine 110, the throttle valve 168, the air-fuel ratio sensor 180, the atmospheric pressure sensor 182, the first pressure sensor 184, the second pressure sensor 186, the supercharger 190, and the evaporated fuel processing device 210. Communication between the control device 250 and each device is performed using, for example, controller area network (CAN) communication.

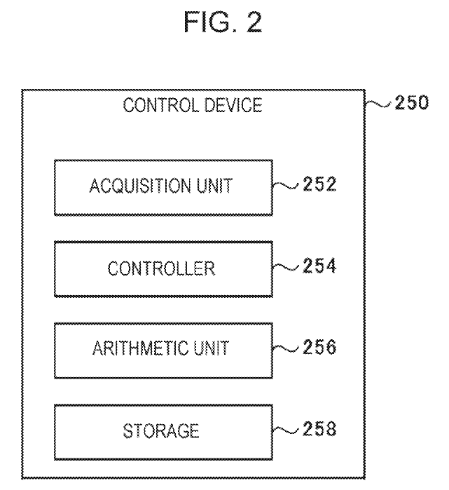

FIG. 2 is a block diagram illustrating the functional configuration of the control device 250 according to the present embodiment. For example, as illustrated in FIG. 2, the control device 250 has an acquisition unit 252, a controller 254, an arithmetic unit 256, and a storage 258. Note that various processes including the processes described below and performed by at least one of the acquisition unit 252, the controller 254, and the arithmetic unit 256 can be performed by the one or more processors 250a. In detail, various processes are performed by the one or more processors 250a executing the programs stored in the one or more memories 250b. The function of the storage 258 is realized by the one or more memories 250b.

The acquisition unit 252 acquires various types of information used in the processing performed by one or both of the controller 254 and the arithmetic unit 256 and outputs such information to one or both of the controller 254 and the arithmetic unit 256. For example, the acquisition unit 252 acquires information from, for example, the engine 110, the air-fuel ratio sensor 180, the atmospheric pressure sensor 182, the first pressure sensor 184, the second pressure sensor 186, the wastegate valve 202, and the valve 226a.

The controller 254 controls the operation of each device provided in the vehicle 100. In the present embodiment, the controller 254 controls the intake valves 140, the exhaust valves 142, the injectors 150, and the spark plugs 152 provided in the respective cylinders 112a of the engine 110 to perform an all-cylinder operation or a reduced-cylinder operation. An all-cylinder operation is an operation using all of the cylinders 112a provided in the engine 110. A reduced-cylinder operation is an operation in which one or more of the cylinders 112a provided in the engine 110 are stopped and the rest of the cylinders 112a are operated. When performing a reduced-cylinder operation, the controller 254 closes, for example, the intake valves 140 and exhaust valves 142 of the cylinders 112a to be stopped and stops fuel injection from the injectors 150.

The controller 254 also adjusts the opening degree of the wastegate valve 202 of the supercharger 190 to adjust supercharging pressure from the compressor 194. For example, the controller 254 increases supercharging pressure from the compressor 194 by reducing the opening degree of the wastegate valve 202. The controller 254 also reduces supercharging pressure from the compressor 194 by increasing the opening degree of the wastegate valve 202.

Note that the torque of the engine 110 increases as the compressor 194 increases supercharging pressure. For example, when performing a reduced-cylinder operation, the controller 254 can achieve the same torque as in an all-cylinder operation performed at the first supercharging pressure, by causing the compressor 194 to increase supercharging pressure to a second supercharging pressure, which is higher than a first supercharging pressure in an all-cylinder operation.

In the present embodiment, the controller 254 performs a first setting process to set the operation mode of the engine 110 and the supercharger 190 to a purge priority mode. The purge priority mode is an operation mode in which the supercharging pressure from the compressor 194 is increased to increase the flow rate of purge gas supplied from the canister 212 to the intake air flow path 160 through the ejector mechanism 220. The purge priority mode is an operating mode for prioritizing purge gas consumption over the fuel economy of the engine 110. The controller 254 may perform a second setting process to set the operation mode of the engine 110 and the supercharger 190 to a fuel-economy priority mode. The controller 254 may also perform a determination process to determine whether to perform the first setting process or the second setting process. The fuel-economy priority mode is an operation mode that improves the fuel economy of the engine 110 while maintaining the torque thereof. The fuel-economy priority mode is an operation mode for prioritizing the fuel economy of the engine 110 over purge gas consumption. Details of the first setting process, the second setting process, and the determination process will be described below.

The arithmetic unit 256 performs, for example, a concentration calculation process and a fuel economy calculation process.

The concentration calculation process is a process that calculates the concentration of evaporated fuel in purge gas supplied from the canister 212 to the intake air flow path 160. For example, in the concentration calculation process, the arithmetic unit 256 calculates the concentration of evaporated fuel based on the detected value from the air-fuel ratio sensor 180 and the flow rate of purge gas. Note that, during supercharging, the arithmetic unit 256 refers to a flow rate map for supercharging, which will be described below, and calculates the flow rate of purge gas based on the detected value from the atmospheric pressure sensor 182, the detected value from the second pressure sensor 186, and the opening degree of the valve 226a. Moreover, during non-supercharging, the arithmetic unit 256 refers to a flow rate map for non-supercharging, which will be described below, and calculates the flow rate of purge gas based on the detected value from the atmospheric pressure sensor 182, the detected value from the first pressure sensor 184, and the opening degree of the valve 226a.

The fuel economy calculation process is a process that calculates a first fuel amount, a second fuel amount, and a third fuel amount when the torque of the engine 110 is the same. The first fuel amount is the amount of fuel supplied to the engine 110 by purge gas. The second fuel amount is the target fuel amount for a reduced-cylinder operation. The third fuel amount is the target fuel amount for an all-cylinder operation. The first fuel amount, the second fuel amount, and the third fuel amount are, for example, fuel amounts per unit time.

For example, in the fuel economy calculation process, the arithmetic unit 256 calculates a first fuel amount based on the concentration of evaporated fuel in purge gas supplied from the canister 212 to the intake air flow path 160 and the flow rate of purge gas. In the fuel economy calculation process, the arithmetic unit 256 refers to a reduced-cylinder fuel economy map, which will be described below, and calculates a second fuel amount based on the rotational speed of the engine 110 and the torque required by the engine 110. In the fuel economy calculation process, the arithmetic unit 256 refers to an all-cylinder fuel economy map, which will be described below, and calculates a third fuel amount based on the rotational speed of the engine 110 and the torque required by the engine 110.

The storage 258 stores, for example, the flow rate map for supercharging, the flow rate map for non-supercharging, the reduced-cylinder fuel economy map, and the all-cylinder fuel economy map.

The flow rate map for supercharging is information in which the difference between the pressure upstream of the throttle valve 168 and atmospheric pressure and the opening degree of the valve 226a are associated with the flow rate of purge gas flowing through the ejector body 222. The flow rate map for non-supercharging is information in which the difference between the pressure in the intake manifold 162 and atmospheric pressure and the opening degree of the valve 226a are associated with the flow rate of purge gas flowing through the second purge flow path 228.

The reduced-cylinder fuel economy map is information in which the rotational speed of the engine 110 and the torque required by the engine 110 are associated with the second fuel amount. The all-cylinder fuel economy map is information in which the rotational speed of the engine 110 and the torque required by the engine 110 are associated with the third fuel amount.

Note that the functions of the control device 250 according to the present embodiment may be divided among multiple devices, or multiple functions may be realized by a single device. When the functions of the control device 250 are divided among multiple devices, the multiple devices may be connected to each other via a communication bus such as CAN.

### 2. Operation of Evaporated Fuel Processing Device

Next, the operation of the evaporated fuel processing device 210 according to the embodiment of the disclosure will be described with reference to FIG. 1.

When intake air is supercharged by the supercharger 190, namely during supercharging, the evaporated fuel stored in the canister 212, together with air supplied from the atmospheric release flow path 212b, is supplied as purge gas to the intake air flow path 160 through the first purge flow path 226 and the ejector body 222. In contrast, when intake air is not supercharged by the supercharger 190, namely during non-supercharging, purge gas is supplied to the intake air flow path 160 through the first purge flow path 226 and the second purge flow path 228.

In more detail, during supercharging, the pressure downstream of the compressor 194 is higher than the pressure upstream thereof along the intake air flow path 160. Thus, the intake air is returned to the ejector body 222 through the return flow path 224. As described above, the end of the return flow path 224 coupled to the ejector body 222 is a tapered nozzle. Thus, the intake air returned to the ejector body 222 through the return flow path 224 is depressurized at the end of the return flow path 224, and the region around the end of the return flow path 224 is under negative pressure. This negative pressure thus draws purge gas from the first purge flow path 226 into the ejector body 222. The drawn purge gas, together with the intake air returned from the return flow path 224, is supplied through the ejector body 222 to the upstream side from the compressor 194 along the intake air flow path 160. The purge gas passes through the compressor 194, the intercooler 166, the throttle valve 168, and the intake manifold 162 and is then supplied from the intake ports 130 to the combustion chamber 126.

Note that the lower the pressure at the region around the end of the return flow path 224, the higher the flow rate of purge gas drawn into the ejector body 222 from the first purge flow path 226. The pressure at the region around the end of the return flow path 224 decreases as the flow rate of intake air flowing through the return flow path 224 increases. The flow rate of intake air flowing through the return flow path 224 increases as the difference between the pressures downstream and upstream of the compressor 194 along the intake air flow path 160 increases, namely the supercharging pressure from the compressor 194 increases. Thus, the higher the supercharging pressure from the compressor 194, the higher the flow rate of purge gas drawn into the ejector body 222 from the first purge flow path 226.

Moreover, since the canister 212 is at atmospheric pressure, the intake manifold 162 is at a higher pressure than the canister 212 during supercharging. Thus, during supercharging, purge gas is hardly supplied to the intake manifold 162 from the canister 212 through the first purge flow path 226 and the second purge flow path 228. Since the second purge flow path 228 has the check valve 228a, it is possible to prevent backflow of intake air from the intake manifold 162 to the first purge flow path 226.

In contrast, the intake manifold 162 is under negative pressure during non-supercharging. Thus, during non-supercharging, purge gas is supplied to the intake manifold 162 from the canister 212 through the first purge flow path 226 and the second purge flow path 228.

Note that, during non-supercharging, the pressure downstream of the compressor 194 is lower than the pressure upstream thereof along the intake air flow path 160. Thus, the intake air is not returned to the ejector body 222 through the return flow path 224. Thus, during non-supercharging, purge gas is hardly supplied to the intake air flow path 160 from the canister 212 through the first purge flow path 226 and the ejector body 222. Since the first purge flow path 226 has the check valve 226b, it is possible to prevent backflow of intake air from the ejector body 222 to the first purge flow path 226.

### 3. Operation of Control Device

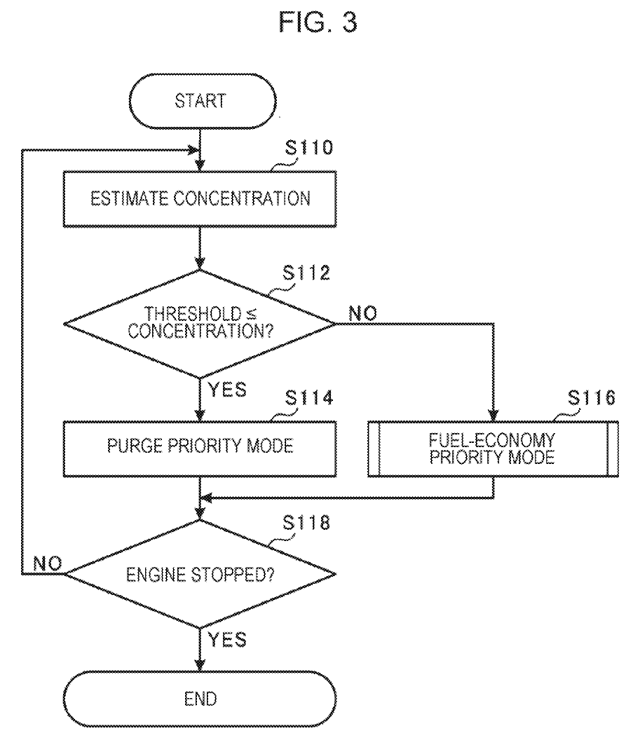

Next, the operation of the control device 250 according to the embodiment of the disclosure will be described with reference to FIG. 3.

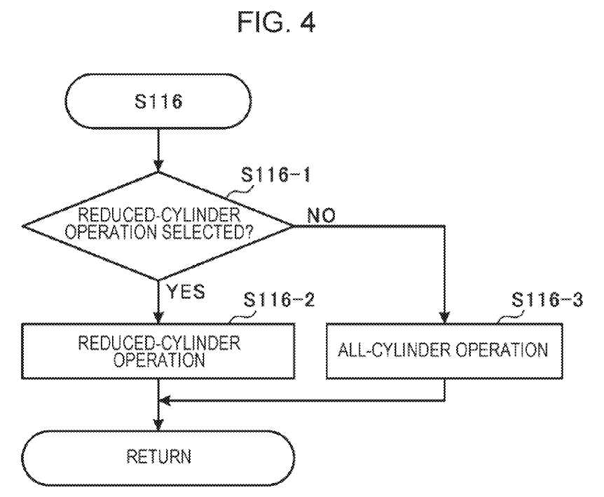

FIG. 3 is a flowchart illustrating an example of the flow of the process performed by the control device 250 according to the present embodiment. FIG. 4 is a flowchart illustrating an example of the flow in Step S116 performed by the control device 250 according to the present embodiment.

As illustrated in FIG. 3, when the engine 110 is operating, first, the arithmetic unit 256 of the control device 250 performs the concentration calculation process to estimate the concentration of evaporated fuel in purge gas in Step S110. Next, in Step S112, the controller 254 of the control device 250 performs the determination process to determine whether to perform the first setting process or the second setting process, based on the concentration of evaporated fuel in the purge gas. For example, in the determination process, the controller 254 determines whether the concentration of evaporated fuel in the purge gas estimated by the arithmetic unit 256 is greater than or equal to a threshold. The threshold is set, for example, based on legal regulations. As a result, when it is determined that the concentration of evaporated fuel is greater than or equal to the threshold (YES in Step S112), the controller 254 causes the process to proceed to Step S114. In contrast, when it is determined that the concentration of evaporated fuel is not greater than or equal to the threshold, namely less than the threshold (NO in Step S112), the controller 254 causes the process to proceed to Step S116.

In Step S114, the controller 254 performs the first setting process to set the operation mode of the engine 110 and the supercharger 190 to the purge priority mode. The purge priority mode is an operation mode in which the supercharging pressure from the supercharger 190 is increased to the second supercharging pressure, which is higher than the first supercharging pressure during an all-cylinder operation, while performing a reduced-cylinder operation, and purge gas containing evaporated fuel is supplied from the ejector mechanism 220 to the intake air flow path 160. When the first setting process ends, the controller 254 causes the process to proceed to Step S118.

In Step S116, the controller 254 performs the second setting process to set the operation mode to the fuel-economy priority mode. The fuel-economy priority mode is an operation mode in which the supercharging pressure from the supercharger 190 is set to the second supercharging pressure or the first supercharging pressure while performing either a reduced-cylinder operation or an all-cylinder operation, and purge gas is supplied from the ejector mechanism 220 to the intake air flow path 160. When the second setting process ends, the controller 254 causes the process to proceed to Step S118.

In Step S118, the controller 254 determines whether the engine 110 has stopped. As a result, when it is determined that the engine 110 has stopped (YES in Step S118), the controller 254 terminates the control flow illustrated in FIG. 3. In contrast, when it is determined that the engine 110 has not stopped (NO in Step S118), the controller 254 causes the process to return to Step S110.

As illustrated in FIG. 4, in the fuel-economy priority mode, the controller 254 performs processing for selecting either a reduced-cylinder operation or an all-cylinder operation in Step S116-1 based on a first fuel amount Q₁, a second fuel amount Q₂, and a third fuel amount Q₃. The first fuel amount Q₁ is supplied to the engine 110 by purge gas. The second fuel amount Q₂ serves as the target fuel amount during a reduced-cylinder operation. The third fuel amount Q₃ serves as the target fuel amount during an all-cylinder operation. In Step S116-1, for example, the controller 254 determines whether the difference between the first fuel amount Q₁ and the second fuel amount Q₂, which is denoted by ΔQ₂ (= Q₂ - Q₁), is less than the difference between the first fuel amount Q₁ and the third fuel amount Q₃, which is denoted by ΔQ₃ (= Q₃ - Q₁). That is, in Step S116-1, the controller 254 determines whether the fuel amount supplied from the injector 150 during a reduced-cylinder operation is less than the fuel amount supplied from the injector 150 during an all-cylinder operation. As a result, when it is determined that the difference ΔQ₂ between the first fuel amount Q₁ and the second fuel amount Q₂ is less than the difference ΔQ₃ between the first fuel amount Q₁ and the third fuel amount Q₃ (YES in Step S116-1), the controller 254 causes the process to proceed to Step S116-2. In contrast, when it is determined that the difference ΔQ₂ between the first fuel amount Q₁ and the second fuel amount Q₂ is greater than or equal to the difference ΔQ₃ between the first fuel amount Q₁ and the third fuel amount Q₃ (NO in Step S116-1), the controller 254 causes the process to proceed to Step S116-3.

In Step S116-2, the controller 254 performs a reduced-cylinder operation. In Step S116-3, the controller 254 performs an all-cylinder operation.

### 4. Example of Operation of Control Device

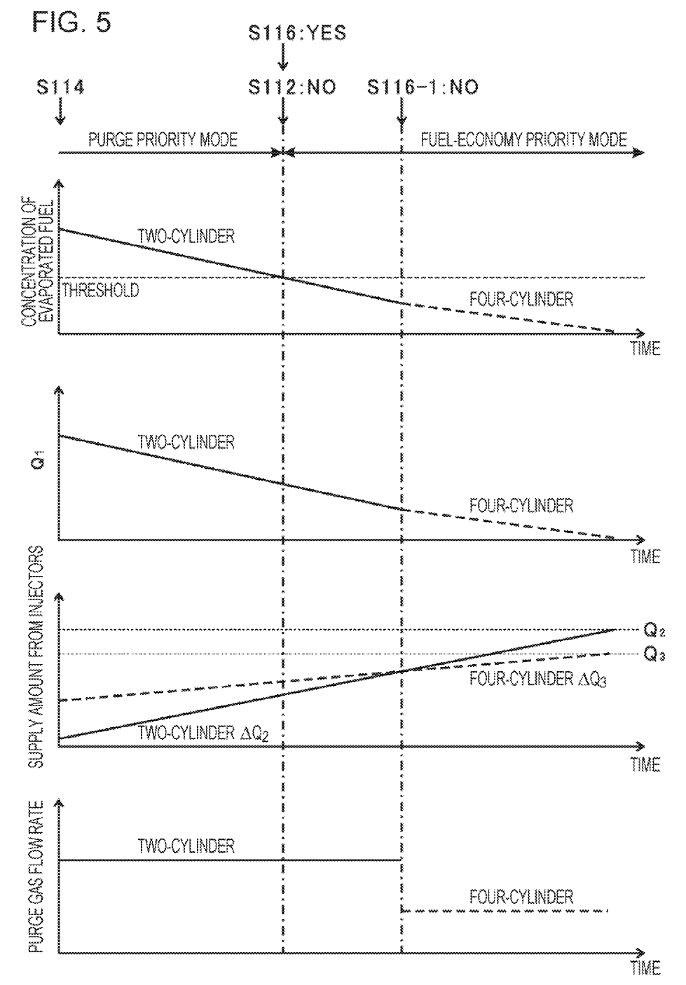

Next, an example of the operation of the control device 250 according to the embodiment of the disclosure will be described with reference to FIG. 5.

FIG. 5 includes graphs for describing the transition of the concentration of evaporated fuel, the transition of the first fuel amount, the transition of the amount of fuel supplied from the injectors 150, and the flow rate of purge gas in the purge priority mode and in the fuel-economy priority mode. In FIG. 5, the solid lines indicate transitions during a reduced-cylinder operation, and the dashed lines indicate transitions during an all-cylinder operation. The example illustrated in FIG. 5 illustrates the case where all of the four cylinders 112a installed in the engine 110 are used in an all-cylinder operation, and the case where two of the cylinders 112a are stopped and two of the cylinders 112a are operated in a reduced-cylinder operation. Note that FIG. 5 illustrates an example of a region where the third fuel amount Q₃, which is the target fuel amount during an all-cylinder operation, is lower than the second fuel amount Q₂, which is the target fuel amount during a reduced-cylinder operation, when the supercharger 190 is supercharging.

For example, when the concentration of evaporated fuel in purge gas becomes higher than or equal to the threshold as the operating time in a four-cylinder operation passes (YES in Step S112), the controller 254 sets the operation mode of the engine 110 and the supercharger 190 to the purge priority mode (Step S114). In the purge priority mode, while performing a two-cylinder operation, the supercharging pressure from the supercharger 190 is increased to the second supercharging pressure, which is higher than the first supercharging pressure during a four-cylinder operation. In this manner, the supercharging pressure is increased to the second supercharging pressure while the purge priority mode is set, so that the flow rate of purge gas becomes higher than that in a four-cylinder operation as illustrated in the bottom graph in FIG. 5. Thus, while the purge priority mode is set, the concentration of evaporated fuel in purge gas gradually decreases, as illustrated in the top graph in FIG. 5. The first fuel amount supplied to the engine 110 by purge gas also gradually decreases, as illustrated in the second graph from the top in FIG. 5. Thus, as illustrated in the third graph from the top in FIG. 5, the fuel amount supplied from the injectors 150 to the combustion chamber 126 gradually increases.

When the concentration of evaporated fuel in purge gas decreases to less than the threshold while the two-cylinder operation is being performed (NO in Step S112), the controller 254 switches the operation mode of the engine 110 and the supercharger 190 from the purge priority mode to the fuel-economy priority mode (Step S116). In this case, as illustrated in the third graph from the top in FIG. 5, the fuel amount supplied from the injectors 150 during a two-cylinder operation, namely the difference ΔQ₂ between the first fuel amount Q₁ and the second fuel amount Q₂, is less than the fuel amount supplied from the injectors 150 during a four-cylinder operation, namely the difference ΔQ₃ between the first fuel amount Q₁ and the third fuel amount Q₃ (YES in Step S116-1). Thus, immediately after switching from the purge priority mode to the fuel-economy priority mode, the two-cylinder operation is maintained (Step S116-2). This can improve the fuel economy of the engine 110.

As the operating time in the two-cylinder operation passes, the first fuel amount gradually decreases. As illustrated in the third graph from the top in FIG. 5, when the fuel amount supplied from the injectors 150 during the two-cylinder operation (the difference ΔQ₂) increases to the fuel amount supplied from the injectors 150 during a four-cylinder operation (the difference ΔQ₃)(NO in Step S116-1), the controller 254 switches from the two-cylinder operation to a four-cylinder operation (Step S116-3). This can suppress deterioration in the fuel economy of the engine 110.

### 5. Effects of Vehicle

Next, the effects of the vehicle 100 according to the embodiment of the disclosure will be described.

The vehicle 100 according to the present embodiment includes the engine 110, the intake air flow path 160, the supercharger 190, the fuel tank 102, the canister 212, the ejector mechanism 220, and the control device 250. The engine 110 has the cylinders 112a. The intake air flow path 160 is coupled to the engine 110. The supercharger 190 is configured to pressurize intake air to be supplied to the engine 110 through the intake air flow path 160. The fuel tank 102 is configured to store fuel to be supplied to the engine 110. The canister 212 is configured to temporarily store evaporated fuel generated in the fuel tank 102. The ejector mechanism 220 has the ejector body 222 provided upstream of the supercharger 190 along the intake air flow path 160, the return flow path 224 configured to couple part of the intake air flow path 160 downstream of the supercharger 190 and the ejector body 222, and the purge flow path 226 configured to couple the canister 212 and the ejector body 222. The control device 250 is configured to control the engine 110 and the supercharger 190. The control device 250 has the one or more processors 250a and the one or more memories 250b coupled to the one or more processors 250a. The one or more processors 250a perform the first setting process to set the operation mode of the engine 110 and the supercharger 190 to the purge priority mode. The purge priority mode is an operation mode in which the supercharging pressure from the supercharger 190 is increased to the second supercharging pressure that is higher than the first supercharging pressure during an all-cylinder operation, while performing a reduced-cylinder operation in which one or more of the cylinders 112a, are stopped, and purge gas containing evaporated fuel is supplied from the ejector mechanism 220 to the intake air flow path 160.

The vehicle 100 according to the present embodiment increases the supercharging pressure in the purge priority mode in this manner and can thus efficiently supply evaporated fuel to the intake air flow path 160. In the purge priority mode according to the present embodiment, the supercharging pressure is increased when a reduced-cylinder operation is performed. Thus, even in a reduced-cylinder operation, the torque of the engine 110 can be increased to the same level as in an all-cylinder operation. Thus, even when an all-cylinder operation is switched to a reduced-cylinder operation, the vehicle 100 according to the present embodiment can suppress fluctuations in the torque of the engine 110. This makes it possible to suppress malfunctions of the vehicle 100 and a reduction in the ride comfort of the vehicle 100.

The one or more processors 250a according to the present embodiment may perform the second setting process to set the operation mode to the fuel-economy priority mode. The fuel-economy priority mode may be an operation mode in which the supercharging pressure from the supercharger 190 is set to the second supercharging pressure or the first supercharging pressure while performing either a reduced-cylinder operation or an all-cylinder operation and purge gas is supplied from the ejector mechanism 220 to the intake air flow path 160.

In this manner, the vehicle 100 according to the present embodiment can both improve the fuel economy of the engine 110 and supply evaporated fuel to the intake air flow path 160. Moreover, the vehicle 100 according to the present embodiment can also supply evaporated fuel to the intake air flow path 160 even in the fuel-economy priority mode in addition to the purge priority mode. Thus, the vehicle 100 according to the present embodiment can extend the time period during which evaporated fuel is supplied from the canister 212 to the intake air flow path 160. Thus, the vehicle 100 according to the present embodiment can supply evaporated fuel to the intake air flow path 160 even more efficiently.

In fuel-economy priority mode, the one or more processors 250a according to the present embodiment may perform processing for selecting either a reduced-cylinder operation or an all-cylinder operation based on the first fuel amount Q₁ supplied to the engine 110 by purge gas, the second fuel amount Q₂ serving as the target fuel amount during a reduced-cylinder operation, and the third fuel amount Q₃ serving as the target fuel amount during an all-cylinder operation. As a result, the vehicle 100 according to the present embodiment can improve the fuel economy of the engine 110 while suppressing fluctuations in the torque of the engine 110.

In the processing for selecting, the one or more processors 250a according to the present embodiment may select a reduced-cylinder operation when the difference ΔQ₂ between the first fuel amount Q₁ and the second fuel amount Q₂ is less than the difference ΔQ₃ between the first fuel amount Q₁ and the third fuel amount Q₃ and may select an all-cylinder operation when the difference ΔQ₂ between the first fuel amount Q₁ and the second fuel amount Q₂ is greater than or equal to the difference ΔQ₃ between the first fuel amount Q₁ and the third fuel amount Q₃. As a result, the vehicle 100 according to the present embodiment can further improve the fuel economy of the engine 110 while suppressing fluctuations in the torque of the engine 110.

In the vehicle 100 according to the present embodiment, the one or more processors 250a may perform the determination process to determine whether to perform the first setting process or the second setting process based on the concentration of evaporated fuel in purge gas.

When the concentration of evaporated fuel is low, if the operation mode is set to the purge priority mode, the fuel economy of the engine 110 may decrease. Thus, the vehicle 100 according to the present embodiment can both improve the fuel economy of the engine 110 and supply evaporated fuel to the intake air flow path 160 by determining whether to perform the first setting process or the second setting process based on the concentration of evaporated fuel in purge gas.

The disclosure is not limited to the embodiment described above. It is clear that a person skilled in the art can conceive of various changes or modifications within the scope of the claims. These changes or modifications are understood to also fall within the technical scope of the disclosure.

For example, the processes described herein using the flowcharts do not have to be performed in the orders illustrated in the flowcharts. Moreover, additional processing steps may be used, and one or more of the processing steps may be omitted.

For example, in the above embodiment, the case has been described as an example in which the supercharger 190 includes the turbine 192, the bypass flow path 200, and the wastegate valve 202. However, the supercharger 190 may include an electric motor, which rotates the compressor 194, in addition to or instead of the turbine 192, the bypass flow path 200, and the wastegate valve 202.

According to the disclosure, evaporated fuel can be efficiently supplied to the intake air flow paths of the engine.

1. A vehicle comprising:
an engine comprising cylinders;
an intake air flow path coupled to the engine;
a supercharger configured to pressurize intake air to be supplied to the engine through the intake air flow path;
a fuel tank configured to store fuel to be supplied to the engine;
a canister configured to temporarily store evaporated fuel generated in the fuel tank;
an ejector mechanism comprising an ejector body provided upstream of the supercharger along the intake air flow path, a return flow path configured to couple the intake air flow path and the ejector body at a position downstream of the supercharger, and a purge flow path configured to couple the canister and the ejector body; and
a control device configured to control the engine and the supercharger,
wherein
the control device comprises one or more processors and one or more memories coupled to the one or more processors,
the one or more processors are configured to perform a first setting process to set an operation mode of the engine and the supercharger to a purge priority mode, and
the purge priority mode is an operation mode in which a supercharging pressure from the supercharger is increased to a second supercharging pressure that is higher than a first supercharging pressure during an all-cylinder operation, while performing a reduced-cylinder operation in which one or more of the cylinders are stopped, and purge gas containing the evaporated fuel is supplied from the ejector mechanism to the intake air flow path.

2. The vehicle according to claim 1, wherein
the one or more processors are configured to perform a second setting process to set the operation mode to a fuel-economy priority mode, and
the fuel-economy priority mode is an operation mode in which the supercharging pressure from the supercharger is set to the second supercharging pressure or the first supercharging pressure while performing either the reduced-cylinder operation or the all-cylinder operation, and the purge gas is supplied from the ejector mechanism to the intake air flow path.

3. The vehicle according to claim 2, wherein
the one or more processors are configured to, in the fuel-economy priority mode, perform processing for selecting either the reduced-cylinder operation or the all-cylinder operation, based on a first fuel amount supplied to the engine by the purge gas, a second fuel amount serving as a target fuel amount during the reduced-cylinder operation, and a third fuel amount serving as a target fuel amount during the all-cylinder operation.

4. The vehicle according to claim 3, wherein
in the processing for selecting, the one or more processors are configured to
select the reduced-cylinder operation when a difference between the first fuel amount and the second fuel amount is less than a difference between the first fuel amount and the third fuel amount, and
select the all-cylinder operation when the difference between the first fuel amount and the second fuel amount is greater than or equal to the difference between the first fuel amount and the third fuel amount.

5. The vehicle according to claim 2, wherein
the one or more processors are configured to perform
a determination process to determine whether to perform the first setting process or the second setting process, based on a concentration of the evaporated fuel in the purge gas.

6. The vehicle according to claim 3, wherein
the one or more processors are configured to perform
a determination process to determine whether to perform the first setting process or the second setting process, based on a concentration of the evaporated fuel in the purge gas.
